(19) United States
(12) Patent Application Publication
(10) Pub. No.: US 2026/0358527 A1
(43) Pub. Date: Nov. 12, 2026

(54) Automated Interference Removal And Landmine Detection Using A Dual Magnetometer Drone System

(71) Applicant: The Regents of The University of Michigan, Ann Arbor, MI (US)

(72) Inventors: Alex HOFFMANN, Annapolis, MD (US); Mathew FINLEY, Brentwood, MD (US); Eftyhia ZESTA, Ellicott City, MD (US); Lauro V. OJEDA, Ann Arbor, MI (US); Mark B. MOLDWIN, Ann Arbor, MI (US)

(73) Assignee: The Regents of The University of Michigan, Ann Arbor, MI (US)

(21) Appl. No.: 19/671,632

(22) Filed: May 8, 2026

Related U.S. Application Data
(60) Provisional application No. 63/802,691, filed on May 9, 2025.

(51) Int. Cl. G01V 3/16; G01V 3/165; G01V 3/38

(52) U.S. Cl. CPC G01V 3/16; G01V 3/165; G01V 3/38

(57) ABSTRACT

The use of Wavelet-Adaptive Interference Cancellation for Underdetermined Platforms (WAIC-UP) algorithm to remove unmanned aerial vehicle (UAV) magnetic signal interference from a pair of magnetometers mounted directly on the UAV. WAIC-UP offers a cost-effect and computationally efficient solution that significantly enhances magnetometer-based landmine detection from UAVs. Rapid Unsupervised Detection of Events (RUDE) algorithm to automatically identify landmines. RUDE combines principal component analysis with unsupervised clustering through a support vector machine to detect anomalies in the magnetometer time series data. The combination of WAIC-UP and RUDE algorithms offers a low-cost and computationally efficient solution that enhances the accuracy and reliability of object detection using UAV-mounted magnetometers.

### CROSS-REFERENCE TO RELATED APPLICATIONS

This application claims the benefit and priority of U.S. Provisional Application No. 63/802,691 filed on May 9, 2025. The entire disclosure of the above application is incorporated herein by reference.

### GOVERNMENT CLAUSE

This invention was made with government support under 80NSSC23K1619 awarded by the National Aeronautics and Space Administration. The government has certain rights in the invention.

### FIELD

The present disclosure relates to a method for object detection through magnetic field measurements.

### BACKGROUND

Landmines continue to pose a severe threat in post-conflict regions, causing long-term humanitarian crises and impeding economic recovery. These hidden hazards not only claim thousands of civilian lives each year but also render extensive areas of landscape unusable. The demining process is both time-consuming and prohibitively expensive. This immense challenge underscores the urgent need for cost-effective and efficient landmine detection and clearance methods to restore safety and revitalize agricultural productivity in affected regions.

Detecting landmines is inherently challenging due to the potential use of non-magnetic materials in mine construction, the varying depths at which mines are buried, and challenging terrain. Unmanned aerial vehicles (UAVs) have emerged as valuable tools for surveying large areas for unexploded ordnance (UXO), equipped with an array of sensors such as ground-penetrating radar (GPR), cameras, and magnetometers. GPR operates by emitting electromagnetic waves into the ground and analyzing the reflected signals to identify anomalies indicative of landmines. While GPR is effective in detecting both metallic and non-metallic mines, its performance can be compromised by factors like soil moisture content and the depth of the buried mines. Visual analysis using machine learning can identify surface-laid or shallow-buried mines by detecting terrain changes, but mines overgrown with vegetation and deeper mines pose challenges, requiring complex image processing techniques. Thermal imaging and acoustic sensing offer additional detection capabilities but are heavily dependent on environmental conditions, which can limit their reliability.

Magnetometers detect disturbances in the Earth's magnetic field caused by ferromagnetic materials, making them particularly useful for locating mines with ferrous content. However, a significant challenge in using magnetometers mounted on UAVs is filtering out magnetic interference generated by the drone itself, which can severely affect detection accuracy. Traditional approaches to mitigate this interference involved mounting the magnetometers on towed platforms to increase their distance from the drone, which limits the maneuverability of the UAV, and applying low-pass filters to the magnetometer signals to remove high-frequency noise. Despite these efforts, such methods have limited success due to the presence of lower-frequency magnetic fields induced by the drone's motors. Moreover, applying a low-pass filter reduces the spatial resolution of the magnetometer measurements, diminishing the accuracy of landmine position estimates. Recent work has attempted to apply the Sheinker and Moldwin Magnetic Gradiometry algorithm to UAV magnetometers for landmine detection; however, this algorithm assumes a single interference source and cannot adequately model the complex, near-field stray magnetic fields produced by UAVs.

This section provides background information related to the present disclosure which is not necessarily prior art.

### SUMMARY

This section provides a general summary of the disclosure, and is not a comprehensive disclosure of its full scope or all of its features.

A method is presented for detecting metal objects using an unmanned aerial vehicle configured with a pair of magnetometers. In one embodiment, the method is comprised generally of receiving a magnetic signal from each magnetometer in the pair of magnetometers by a computer processor; applying a wavelet transform to the two magnetic signals, which yields a first wavelet signals and a second wavelet signal by the computer processor; calculating a difference between the first wavelet signal and the second wavelet signal by the computer processor; computing, by the computer processor, a gain factor for the pair of magnetometers based in part of the difference between the first wavelet signal and the second wavelet signal, where the gain factor represents a difference in distance between an interference source and each of the magnetometers in the pair of magnetometers; reconstructing an ambient magnetic field signal in wavelet domain using the gain factor by the computer processor; applying an inverse wavelet transform to the ambient magnetic field signal in the wavelet domain to yield an ambient magnetic field signal in time domain by the computer processor; and detecting an object using the ambient magnetic field signal in the time domain by the computer processor.

In another aspect, the gain factor is computed by

$$\frac{Σ D ( s ) W 2 ( s )}{Σ D ( s ) W 1 ( s )} ,$$

where D(s) the difference between the first wavelet signal and the second wavelet signal, W₁(s) is the first wavelet signal, and W₂(s) is the second wavelet signal.

In another aspect, the ambient magnetic field signal in the wavelet domain is computed according to

$$\frac{\hat{K} ( s ) W 1 ( s ) - W 2 ( s )}{{K}^{′} ( s ) - 1} ,$$

where \hat{K}(s) is the computed gain factor, W₁(s) is the first wavelet signal, and W₂(s) is the second wavelet signal.

In a further aspect, detecting an object using the ambient magnetic field signal in the time domain includes identifying anomalies in the ambient magnetic field signal in the time domain, receiving position data for the UAV, correlating the identified anomalies with the position data of the UAV, and reporting occurrence of an object at the identified anomalies with position data of the UAV at the identified anomalies.

According to a further aspect, identifying anomalies in the ambient magnetic field signal in the time domain uses a support vector machine.

According to a further aspect, the support vector is a one-class support vector machine.

In another aspect, prior to identifying anomalies in the ambient magnetic field signal, principal component analysis is applied to the ambient magnetic field in the time domain.

In yet another aspect, this technique can be extended to UAVs having more than two magnetometers. The method includes: receiving a magnetic signal from each magnetometer in the two or more magnetometers; applying a wavelet transform to the magnetic signals from the two or more magnetometers, thereby yielding a set of wavelet signals; calculating a difference between signals in the set of wavelet signals; computing a gain factor for the two or more magnetometers based in part of the difference between the signals in the set of wavelet signals, where the gain factor represents a difference in distance between an interference source and each of the magnetometers in the two or more magnetometers; reconstructing an ambient magnetic field signal in wavelet domain using the gain factor; applying an inverse wavelet transform to the ambient magnetic field signal in the wavelet domain to yield an ambient magnetic field signal in time domain; and detecting an object using the ambient magnetic field signal in the time domain.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 illustrates a perspective view of an exemplary unmanned aerial vehicle (UAV);

FIG. 2 is a block diagram of an example UAV with a controller and the pair of magnetometers;

FIG. 3 is a flowchart showing the steps for detecting metal objects by a computer processor using a UAV configured with a pair of magnetometers;

FIG. 4 is a flowchart showing the steps for detecting an object using an ambient magnetic field signal in the time domain;

FIG. 5A is a graph showing the UAV serpentine flight path over a 10 m×10 m grid for landmine detection;

FIG. 5B is a graph showing the layout of the UAV's quadcopter motor setup;

FIG. 6A is a graph showing the raw magnetometer signal composed of UAV interference and landmine signals;

FIG. 6B is a graph showing the clean magnetometer signal of FIG. 6A after applying the WAIC-UP algorithm to the raw magnetometer signal;

FIG. 6C is a graph showing the magnetometer signal of FIG. 6A with no magnetic interference;

FIG. 7A is a graph showing raw absolute magnetic field signal from a magnetometer in a UAV simulation;

FIG. 7B is a graph showing the magnetic field signal of FIG. 7A after applying the WAIC-UP algorithm;

FIG. 7C is a graph showing the magnetic field signal of FIG. 7A after applying a simple low-pass filter;

FIG. 8 is a table showing the mean correlation for the low-pass and WAIC-UP techniques applied to magnetic field signals for landmine detection;

FIG. 9 is a graph showing the error in magnetometers between estimated landmine positions and the actual center of landmines for each interference removal and detection method;

FIG. 10 is a graph showing the performance of difference combinations of landmine detection algorithms in terms of F1-Score on the left axis and correlation on the right axis as a function of UAV altitude.

Corresponding reference numerals indicate corresponding parts throughout the several views of the drawings.

### DETAILED DESCRIPTION

Example embodiments will now be described more fully with reference to the accompanying drawings.

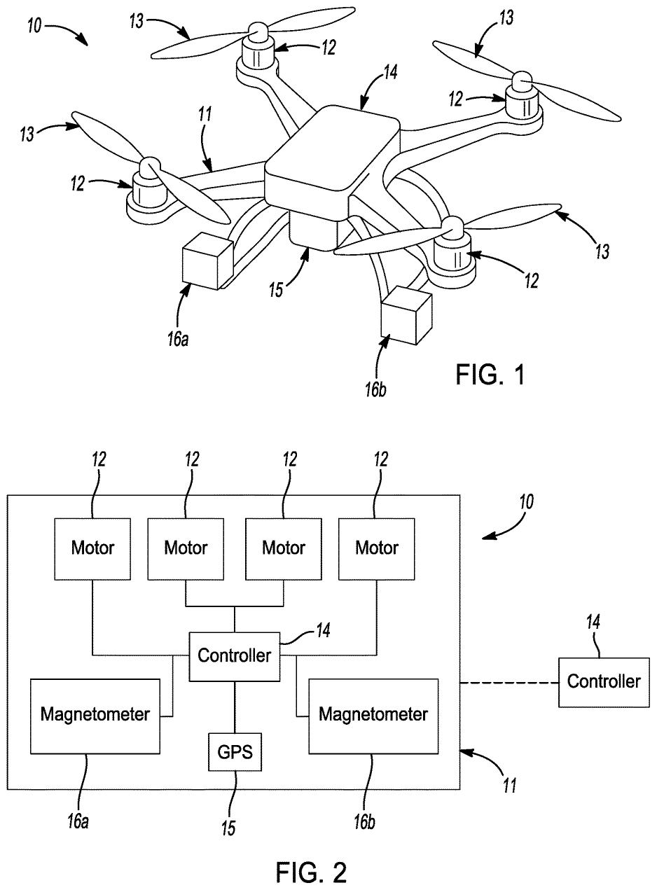

FIG. 1 illustrates an exemplary unmanned aerial vehicle (UAV) 10. UAVs are useful for traversing a landscape at a user-defined height above the ground. UAVs are typically fixed wing aerial vehicles, multirotor drones, and hybrid UAVs. The example embodiment depicts the UAV 10 as a multirotor drone including a frame 11, electric motors 12, propellers 13, a controller 14, a global positioning system (GPS) 15, a first magnetometer 16a, and a second magnetometer 16b. The pair of magnetometers 16a, 16b are mounted to the UAV 10 to measure and record magnetic signals affected by both magnetic field signals of the landscape and stray magnetic field interference from the electric motors 12 of the UAV 10. Ideally, magnetic field signals of the landscape would only be measured for object detection, for example, landmines in the landscape, but stray magnetic interference is also measured and recorded by the pair of magnetometers 16a, 16b. The example embodiment, as shown in FIG. 1, depicts the UAV 10 as having four electric motors 12, but it is contemplated the UAV 10 can include fewer or additional electric motors. The UAV 10 includes a GPS 15, but it is contemplated the GPS 15 can be another position tracking device, like a Bluetooth tracking device, radio frequency identification (RFID), or an inertial tracking system, depending on the UAV 10 requirements.

FIG. 2 illustrates a block diagram of the exemplary UAV 10. The controller 14 of the UAV 10 can control the flight path of the UAV 10 over the landscape through communication with the electric motors 12. In an exemplary embodiment, the controller 14 is inside the frame 11 and in wired or wireless communication with the UAV 10 components. In another embodiment, the controller 14 is outside the frame 11 and in wireless communication with the UAV 10. The controller 14 receives magnetic signals from the pair of magnetometers 16a, 16b.

In an exemplary embodiment, the controller 14 is implemented as a microcontroller. It should be understood that the logic for the control of the UAV 10 and computations by the controller 14 can be implemented in hardware logic, software logic, or a combination of hardware and software logic. In this regard, controller 14 can be or can include any of a digital signal processor (DSP), microprocessor, microcontroller, or other programmable device which are programmed with software implementing the above described methods. It should be understood that alternatively the controller 14 is or includes other logic devices, such as a Field Programmable Gate Array (FPGA), a complex programmable logic device (CPLD), or application specific integrated circuit (ASIC). When it is stated that controller 14 performs a function or is configured to perform a function, it should be understood that controller 14 is configured to do so with appropriate logic (such as in software, logic devices, or a combination thereof).

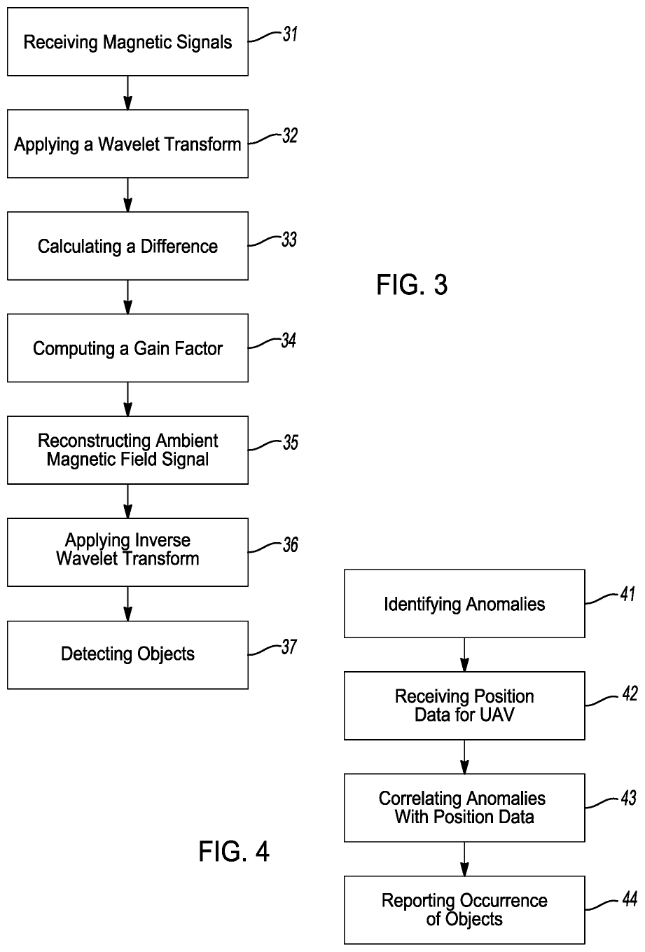

FIG. 3 depicts a method for detecting metal objects using an unmanned aerial vehicle (UAV), where the UAV is equipped with two magnetometers. The controller of the UAV receives a magnetic signal from each magnetometer as shown at 31. It is envisioned that the method may be extended to UAVs equipped with more than two magnetometers.

To mitigate magnetic interference with the magnetic signals measured by the pair of magnetometers in the UAV, a Wavelet-Adaptive Interference Cancellation for Underdetermined Platforms (WAIC-UP) algorithm is implemented. The key principle of WAIC-UP lies in leveraging the spectral difference between the ambient magnetic field and the UAV interference, making it well-suited for magnetometer payloads mounted directly on the UAV frame. The algorithm assumes two magnetometers, B1(t) and B2(t), which records the mixed magnetic signals affected by both ambient magnetic fields and UAV interference. The system can be modeled as a linear mixing of two components: the ambient magnetic field signal, S_{L}(t), and the stray magnetic field signal from the UAV, S_{UAV} (t).

The time-domain relationship of the magnetic signals, B₁(t) and B₂(t), recorded by the pair of magnetometers and received by the controller can be expressed as:

$$[ \begin{matrix}B 1 ( t ) \\ B 2 ( t )\end{matrix} ] = [ \begin{matrix}1 & 1 \\ 1 & k\end{matrix} ] [ \begin{matrix}SL ( t ) \\ SUAV ( t )\end{matrix} ]$$

where k is a gain factor that accounts for the relative contribution of the interference to the second magnetometer. Here, S_{L}(t) represents the ambient magnetic field signal aimed to be recovered, while S_{UAV}(t) denotes the stray magnetic field interference generated by the UAV. It is contemplated the stray magnetic field interference can be generated from another source other than the UAV.

Continuing with FIG. 3, the time-domain system assumes that the stray magnetic field interference is a single multipole field and has limited ability to resolve multiple interference signals. To overcome this issue, a wavelet transform can be applied at 32 to the time-domain relationship of the magnetic signals recorded by the pair of magnetometers, thereby yielding a first wavelet signal and a second wavelet signal. In an example embodiment, the wavelet transform is a continuous wavelet transform, which transforms the received magnetic signals into the wavelet domain:

$$\{ \begin{matrix}{W}_{1} ( s ) = X ( s ) + A ( s ) + {ω}_{1} ( s ) \\ {W}_{2} ( s ) = X ( s ) + KA ( s ) + {ω}_{2} ( s )\end{matrix}$$

where a first wavelet signal, W₁(s), and a second wavelet signal, W₂(s), are wavelet transforms of the first magnetometer recording, B₁(t), and the second magnetometer recording, B₂(t), respectively, at scale s. X(s) represents the wavelet coefficients of the ambient magnetic field signal, and A(s) represents the wavelet coefficients of the stray magnetic field interference. Terms ω₁(s) and ω₂(s) account for noise in the pair of magnetometers measurements, and K is a scale-dependent gain factor that defines the contribution of the interference signal at each magnetometer.

Next, as depicted in FIG. 3, a difference is calculated between the first wavelet signal and the second wavelet signal as indicated at 33. More specifically, the difference between the two wavelet signals is calculated as:

$$\{ \begin{matrix}D ( s ) = {W}_{2} ( s ) - {W}_{1} ( s ) \\ D ( s ) = ( K - 1 ) A ( s ) + {ω}_{2} ( s ) - {ω}_{1} ( s )\end{matrix}$$

Given that the ambient magnetic field signal X(s) is common to the pair of magnetometers, the difference D(s) isolates the contribution of the stray magnetic field interference signal A(s).

For each wavelet scale, s, a gain factor K is computed at 34 for the pair of magnetometers based in part of the difference between the first wavelet signal and the second wavelet signal. The gain factor represents a difference in distance between an interference source and each of the magnetometers. In the exemplary embodiment, the gain factor is computed as follows. Let B₁ and B₂ be the magnetic measurement signals comprised of an ambient magnetic field Bₐ and an interference field B_{UAV}. The two magnetic measurement signals can be expressed as

B₁=Bₐ+B_{U AV}

B₂=Bₐ+KB_{U AV}
Assume the Bₐ and B_{U AV} are not correlated. Since Bₐ is equal at each sensor, the difference between the two magnetic measurement signals may be expressed as

D=B₁−B₂=(1−K)B_{U AV}
In this way, the interference signal scaled by 1−K is isolated. Next, the difference is correlated with each of the two magnetic measurement signals as follows:

C1=DB₁=(1−K)B_{U AV} B_{U AV}

C2=DB₂=K(1−K)B_{UAV} B_{U AV}
C2 has an extra gain factor such that the gain factor, K, can be determined through the ratio of the correlated signals:

K=C2/C1

Returning to the wavelet domain, the gain factor may be determined as

$$\hat{K} ( s ) = \frac{\sum D ( s ) {W}_{2} ( s )}{\sum D ( s ) {W}_{1} ( s )}$$

where D(s) is the difference between the first wavelet signal and the second wavelet signal, W₁(s) is the first wavelet signal, and W₂(s) is the second wavelet signal.

As shown in FIG. 3, and with the estimated gain factor, K, the ambient magnetic field signal is reconstructed at 35 in the wavelet domain using the gain factor as follows:

$$\hat{X} ( s ) = \frac{\hat{K} ( s ) {W}_{1} ( s ) - {W}_{2} ( s )}{\hat{K} ( s ) - 1}$$

An inverse wavelet transform is then applied at 36 to the reconstructed ambient magnetic field signal, thereby yielding the ambient magnetic field signal in the time domain. Objects can then be detected 37 from the ambient magnetic field signal in the time domain with stray magnetic interference removed from the magnetic signals measured and recorded by the pair of magnetometers. This method allows for accurate and computationally efficient interference cancellation, enabling reliable detection of objects using the magnetic field signals in the time-domain.

In other embodiments, this technique can be extended to UAVs having two or more magnetometers. Magnetometer signals from the two or more magnetometers are represented as B(n)=[b1(n), b2(n) . . . bm(n)], and their wavelet series as W(s)=[W₁(s), W₂(s) . . . Wm(s)]. Next, estimate a series of ambient magnetic field signals X(s)=[X1(s), X2(s) . . . XZ(s)], where Z=M(M−1)/2 is the number of unique pairs. One can define a new ambient magnetic field signal, X_f (s), by selecting the minimum magnitude among X(s) for each scale and time point. The algorithm is summarized as follows:

Algorithm 1 WAIC-UP for Multiple Magnetometers

Input: B(n)
Output: x(n)
Initialization :
1: W(s) = Ψ{B(n)}
2: Pairs = (i,j) | i ϵ range(m) and j ϵ range(i + 1,m)
Clean All Pairwise Combinations
3: for (i,j) ϵ Pairs do
4: X(s) ← X(s) + [clean(Wᵢ(s),Wⱼ(s))]
5: end for
Save Time-Scale Points with Minimum Interference
6: for (τ, sⱼ) ϵ (τ ϵ T,j = 1,...,J) do
7: i = argmin(|X(sⱼ,τ)|)
8: X_{f}(sⱼ,τ) ← Xᵢ(sⱼ,τ)
9: end for
10: x(n) = Ψ⁻¹{X_{f}(s)}
11: return x(n)

Owing to the spatial structure of magnetic fields (i.e., dipolar, quadrupolar, etc.), it is highly likely that some stray magnetic fields may not appear at all on the axis of one magnetometer while having a large magnitude at another magnetometer. As a result of this spatial structure, the performance of the algorithm improves with each additional spatially distributed magnetometer.

FIG. 4 depicts an exemplary method for detecting an object using the ambient magnetic field signal in the time domain. First, the controller of the UAV identifies anomalies in the ambient magnetic field signal in the time domain as shown at 41. In an exemplary embodiment, a support vector machine can be used in another embodiment for identifying the anomalies. It is contemplated the support vector machine can be a one-class support vector machine or another support vector machine able to identify anomalies. In the example embodiment, and prior to identifying anomalies in the ambient magnetic field signal, principal component analysis may be applied to the ambient magnetic field signal in the time domain. It is contemplated the principal component analysis can be Dynamic Principal Component Analysis (D-PCA).

Continuing with FIG. 4, after anomalies are identified as depicted at 41, position data for the UAV is received by the controller as shown at 42. In an exemplary embodiment, the position data is received by the controller from the GPS of the UAV. The identified anomalies and receipt of position data for the UAV by the controller allows for correlation of the identified anomalies and position data of the UAV as shown at 43. After correlating the identified anomalies with the received positional data, occurrences of objects are reported as shown at 44. In an example embodiment, the method as depicted in FIG. 4 can be applied iteratively and create a confidence score for the detection of objects based in part of the reported occurrence of objects at the identified anomalies in the ambient magnetic signal in the time domain. In another embodiment, the detection of objects in the ambient magnetic signal in the time domain can be performed noniteratively and objects can be detected by a user from the ambient magnetic signal in the time domain at the reported occurrences of objects.

In an example embodiment of the method illustrated in FIG. 4, a Rapid Unsupervised Detection of Events (RUDE) algorithm is employed to automatically detect objects via the identification of anomalies in the magnetic signals measured by the pair of magnetometers on the UAV. The RUDE algorithm leverages Dynamic Principal Component Analysis (D-PCA) to reduce the dimensionality of the measured time series data, and unsupervised clustering is then used to identify the most statistically significant features (i.e., anomalous data) while filtering out noise and redundant information. This approach allows RUDE to detect and report the occurrence of an object at the identified anomalies without the need for prior information or rules regarding the strength or spectral content of the magnetic signature.

In RUDE, the ambient magnetic field signal in the time domain can be reduced into a trajectory matrix, denoted as X. The matrix can be constructed by concatenating consecutive intervals of the input time series into matrix form as:

$$X = [ \begin{matrix}x ( 1 ) & x ( L + 1 ) & … & x ( RL - L + 1 ) \\ x ( 2 ) & x ( L + 2 ) & … & x ( RL - L + 2 ) \\ ⋮ & ⋮ & ⋱ & ⋮ \\ x ( L ) & x ( 2 l ) & … & x ( RL )\end{matrix} ]$$

where R is the number of intervals and L is the length of each interval. X is then passed through a traditional PCA decomposition, and a low number of principal components are retained (in this manuscript's examples only two components are considered in subsequent steps). Using the reduced trajectory matrix as input to PCA provides greater information about the temporal structure of the time series, on the scale of the window length (L) during this decomposition step.

Next, the reduced-dimension, for example, two dimension corresponding to the two components retained after PCA, representation of the original time-series data can be passed through the unsupervised clustering provided by a support vector machine. An example of a support vector machine is a One Class Support Vector Machine (OC-SVM). The output of the OC-SVM can be a binary label associated with each of the points produced by the decomposition step, identifying the point as anomalous or nominal. These labels are then inverted onto the original time series, along with receiving position data for the UAV from the GPS, and each sample in the input data is designated as anomalous or nominal. This allows for correlating the identified anomalies with the position data of the UAV and reporting the occurrence of an object at the identified anomalies, along with position data of the UAV at the identified anomalies.

For this application, the method depicted in FIG. 4 and the RUDE algorithm can be applied iteratively. For each sample in the time-series input data, a confidence score can be computed by normalizing the summation of the binary detections across a range of window lengths. This confidence score reflects anomaly likelihood instead of a binary anomaly detection. Samples where the confidence score exceeds a user-defined threshold can then be selected for further analysis. To enhance the accuracy of landmine localization, the Hierarchical Density-Based Spatial Clustering of Applications with Noise (HDBSCAN) algorithm can be applied to cluster the UAV positions at the selected points, grouping them based on their spatial proximity. HDBSCAN efficiently clusters the UAV positions, filtering out noise and allowing the detection of the center of each object. Together, RUDE and HDBSCAN form a low-cost, computationally efficient framework for object detection and localization using the pair of magnetometers mounted on the UAV.

To evaluate the performance of the combined WAICUP and RUDE algorithms in mitigating UAV interference and detecting objects, like landmines, two Monte Carlo benchmark simulations were designed using Magpylib to model the magnetic fields generated by both landmines and UAVs. In addition to testing the algorithms, a baseline comparison was performed against low-pass filtering for interference removal and simple thresholding for landmine detection. Low-pass filtering attenuates high-frequency components of the signal to reduce noise and interference, while thresholding identifies anomalies by flagging signal values that exceed a predefined magnitude.

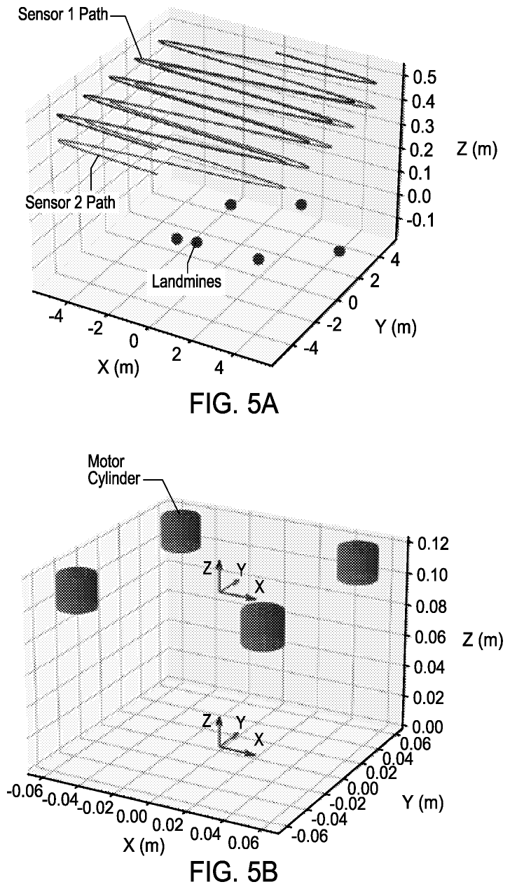

In the first benchmark, a simulated 10 m×10 m grid containing several M19 non-magnetic anti-tank mines was used. These mines have minimal metal content, but still have an appreciable magnetic footprint. These simulated non-magnetic antitank mines were chosen to challenge the detection algorithms under difficult conditions. The landmines were randomly placed within the grid, maintaining a minimum separation of 2 meters between any two mines, and buried at depths ranging from 0 to 15 cm. A UAV equipped with two magnetometers traversed the grid following a serpentine flight path at a constant altitude of 50 cm and a speed of 1 m/s, resulting in a spatial resolution of approximately 1 cm per sample. The entire flight path took 100 seconds to complete. Alternative speeds and sampling rates can be chosen depending on the size of the area being surveyed. FIGS. 5A and 5B illustrate the UAV design and an example landmine placement and UAV flight path.

The UAV was modeled as a quadcopter with four brushless permanent magnet synchronous (BPMS) motors arranged in a square configuration, with each side of the square measuring 10 cm. Two magnetometers were placed on the UAV and sampled at 100 Hz. The first magnetometer was positioned at the center of the square formed by the motors, in the same plane as the motors. The second magnetometer was mounted directly below the first, 10 cm beneath the plane of the motors. To simulate the inherent measurement uncertainty of the magnetometers, random normal noise was added with a 10 nT standard deviation to each measurement channel, reflecting the typical performance of low-cost magnetometers.

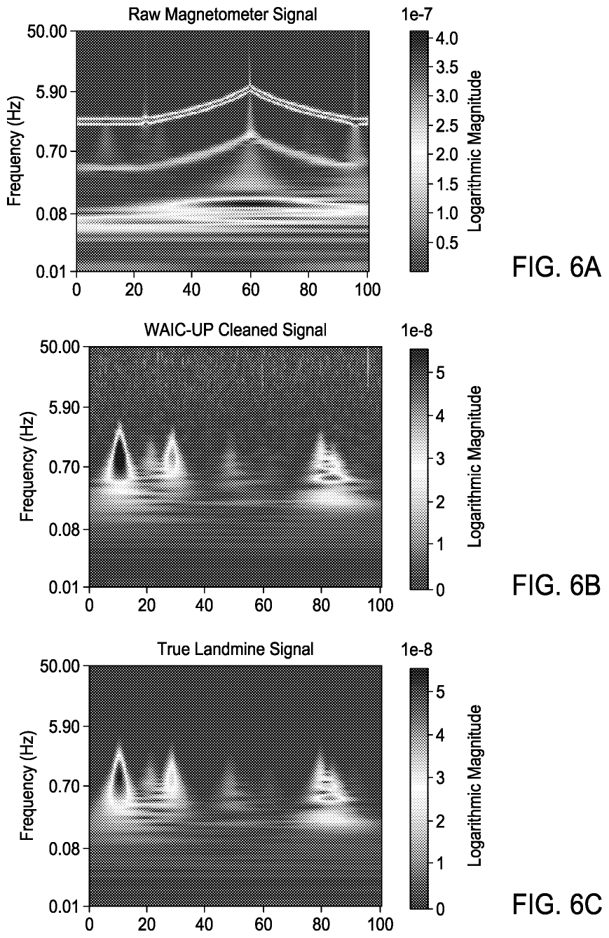

To characterize the UAV's motor interference signals, a model was followed. Each motor's interference comprised three components: the magnetic field from the motor's mechanical rotation (FMR), the rotating permanent magnet pairs (FPM), and the induced magnetic field (FIMF), with base frequencies set to 0.055 Hz, 0.39 Hz, and 2 Hz, respectively. To simulate variations in UAV motion such as acceleration and deceleration, the interference signals were randomly chirped by a factor between 1 and 5. Each motor component was simulated with dipole moments of 10 to 40 mA·m2 based on measurements. At a distance of 10 cm from the motors, the magnetic field strength ranges from 2000 to 8000 nT. Additionally, these interference frequencies overlap with the spectral content of landmines, which increases the complexity of separating landmine signals from the interference. FIGS. 6A, 6B, and 6C present an example spectrograms of the raw magnetic field, the WAIC-UP cleaned signal, and the true ambient magnetic field, respectively.

In this benchmark, 250 randomized simulations were conducted, each containing between three and six landmines randomly positioned within the grid. The purpose was to create a set of diverse interference scenarios that enable the statistical evaluation of the WAIC-UP and RUDE algorithms compared to traditional methods. Four cases were evaluated: (1) data cleaned using WAICUP with landmines detected by the RUDE algorithm; (2) data filtered with a standard 0.5 Hz low-pass filter and detection handled by RUDE; (3) data cleaned using WAIC-UP followed by simple thresholding for detection; and (4) data filtered with the low-pass filter followed by thresholding.

The second benchmark assessed the efficacy of the proposed algorithms with respect to UAV altitude. 35 simulations were conducted for each altitude, ranging from 50 cm to 3 m in 10 cm increments, while keeping the landmine positions fixed. This resulted in over a thousand simulations to evaluate the algorithms' performance at various heights. The thresholds for the thresholding detection method were set to 25 nT, which is 2.5 times the standard deviation of the measurement uncertainty.

For each simulation, the HDBSCAN clustering algorithm to the UAV's recorded positions was applied where the RUDE algorithm or thresholding technique identified anomalies. Detections within 1 meter of a landmine were classified as true positives, while detections outside this range were considered false positives. Any landmines without an estimated detection within 1 meter were marked as false negatives.

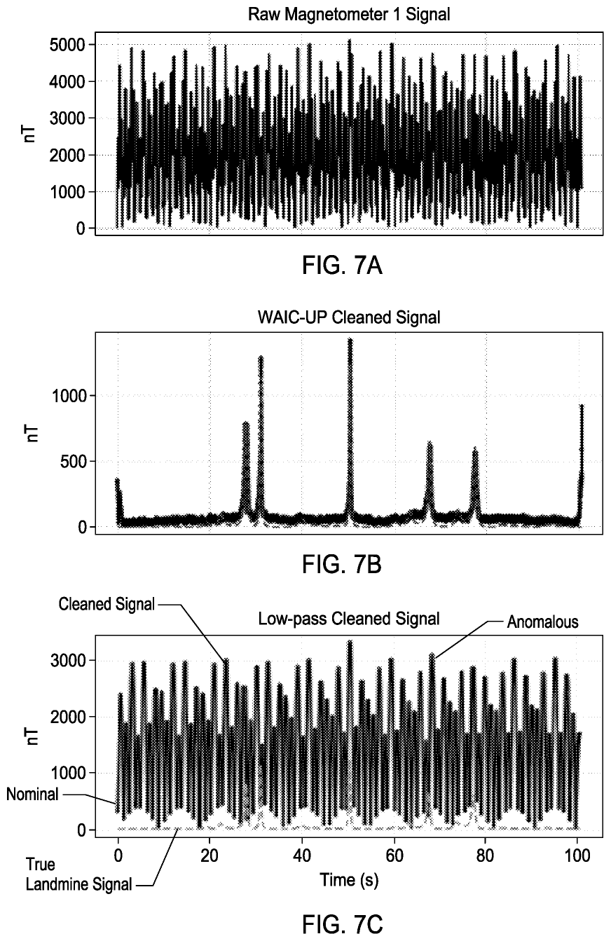

Benchmark 1 evaluates the proposed interference removal and landmine detection algorithm through 250 randomized simulations. Each simulation has between 3 and 6 mines, simulated using the magnetic moment of the M19 minimum-metal anti-tank mine from. The M19 landmine has a large, square plastic body measuring 33 cm in diameter and 10 cm in height. The plastic casing houses only a few metal elements, including a thin stainless steel pressure plate, a copper detonator capsule, and a stainless steel firing pin. In each simulation, either WAIC-UP or a low-pass filter was used to clean the raw magnetometer signals. After removing the noise, either the RUDE algorithm or thresholding was used to determine the presence of a landmine. The threshold for detection was set to 50 nT, and the confidence score threshold for detection with RUDE was set to 0.7. An example time-series that shows the WAIC-UP and low-pass filter results with the RUDE detection algorithm is show in FIGS. 7A, 7B, and 7C.

The landmine detections to the position of the UAV were mapped and located using the HDBSCAN clustering algorithm. From these located detections, the number of True Positives (TP), False Positives (FP), and False Negatives (FN) were recorded for each method of WAIC-UP/Low-pass and RUDE/Thresholding.

To evaluate the performance of the detection methods, precision, recall, F1-Score, and threat score was calculated. Precision measures the proportion of detected landmines that are actually true landmines. It is defined as:

$$Precision = \frac{TP}{TP + FP}$$

Recall, also known as sensitivity, measures the proportion of actual landmines that were correctly detected. It is defined as:

$$Recall = \frac{TP}{TP + FN}$$

F1-Score is the harmonic mean of Precision and Recall, providing a balance between the two. It is defined as:

$$F 1 Score = 2 \times \frac{Precision \times Recall}{Precision + Recall}$$

Threat Score, also known as Critical Success Index, measures the proportion of correct detections relative to all detections and missed detections, excluding true negatives. It is defined as:

$$Threat Score = \frac{TP}{TP + FN + FP}$$

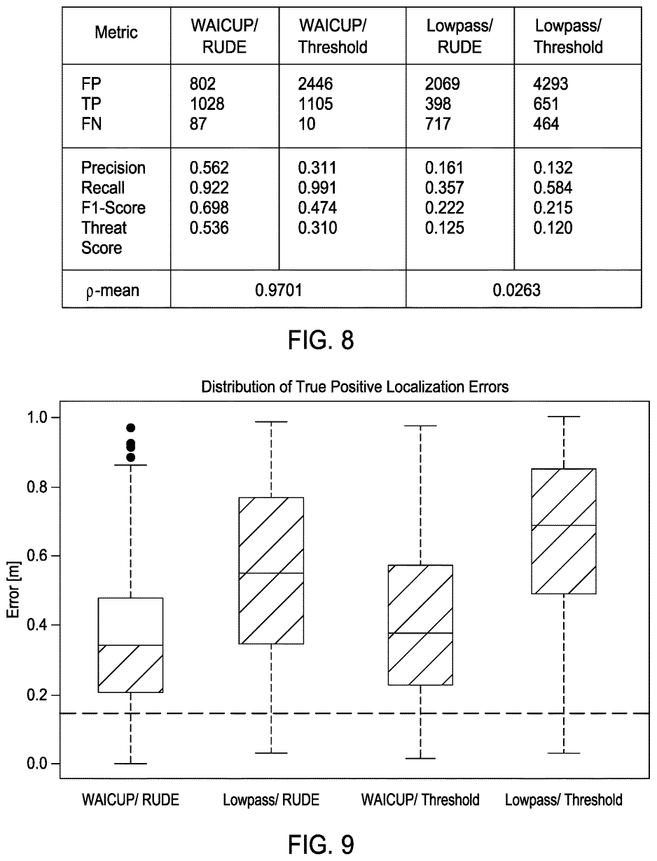

Additionally, the Pearson correlation coefficient ρ was calculated between the cleaned magnetometer signals and true landmine magnetic field signal without UAV interference. The correlation coefficient is defined as:

$$ρ = \frac{\sum ( {X}_{i} - \overline{X} ) ( {Y}_{i} - \overline{Y} )}{\sqrt{\sum {( {X}_{i} - \overline{X} )}^{2} \sum {( {Y}_{i} - \overline{Y} )}^{2}}}$$

where Xᵢ and Yᵢ are the cleaned magnetometer signal and landmine magnetic field signals, respectively, and X̅ and Y̅ are their mean values. The results for each metric over the full 250 simulations are shown in FIG. 8.

From the results in FIG. 8, it is observed that the combination of WAIC-UP interference removal and the RUDE detection algorithm achieved the highest overall performance. It attained a Precision of 0.562 and a Recall of 0.922, resulting in an F1-Score of 0.698 and a Threat Score of 0.536. This indicates that over 92% of actual landmines were correctly detected, and more than half of the detections were true positives. WAIC-UP with thresholding has a higher Recall of 0.991, however, the false positive rate is three times larger. The high correlation coefficient between the WAIC-UP cleaned signal and the true landmine magnetic field signal of ρ=0.9701 further demonstrates strong interference removal capabilities of the WAIC-UP algorithm over traditional low-pass filtering.

In contrast, using a low-pass filter for interference removal significantly reduced the performance of both detection methods. The Low-pass/RUDE combination yielded a Precision of 0.161 and a Recall of 0.357, while the Low-pass/Threshold method had the lowest Precision and F1-Score among all methods. These low performance metrics suggest that the low-pass filter was ineffective at removing UAV interference without distorting the landmine signals, leading to a high number of false positives and missed detections. Overall, the superior performance of the WAIC-UP methods, especially when combined with the RUDE algorithm, confirms the effectiveness of our proposed approach in preserving landmine signals while eliminating UAV-induced noise. This is critical in real-world demining operations, where both missed detections and false positives carry substantial risks.

For each true positive detection, Euclidean distance was recorded between the estimated landmine position and the actual center of the landmine. Although the landmines were randomly buried at depths between 0 and 15 cm, the X-Y position was the focus and not the estimated depth. The distribution of the distance from the estimated landmine position to the center of the landmine is shown in FIG. 9.

The WAIC-UP combined with RUDE algorithm demonstrated the lowest median localization error of 36 cm, indicating superior accuracy. In contrast, the lowpass filter-based methods showed significantly higher median errors of 55 cm and 65 cm, reflecting less precise landmine localization. WAIC-UP's tighter distribution and fewer outliers further underscore its advantage in spatial resolution. Notably, these results suggest that WAICUP's improved accuracy could facilitate safer demining operations, as the robotic mine excavator by, with a width of 87.6 cm, would benefit from more precise landmine positioning.

In the second benchmark, the performance of the WAIC-UP and RUDE algorithms were evaluated across different UAV altitudes, ranging from 50 cm to 3 m in 10 cm increments. Unlike the first benchmark, the landmines in these simulations were fixed at the corners of a 6 m×6 m square, centered in the grid. For each altitude, 35 simulations were conducted using a seeded random number generator to ensure the same set of conditions at every height, resulting in over a thousand simulations in total. This approach is useful for gauging performance with variable terrain or landmine depth, as the altitude changes simulate different real-world conditions. The threshold for the hard thresholding detection method was set at 25 nT, while the confidence score threshold for RUDE was set to 0.70. The simulated UAV flew the same serpentine pattern as in FIGS. 5A and 5B.

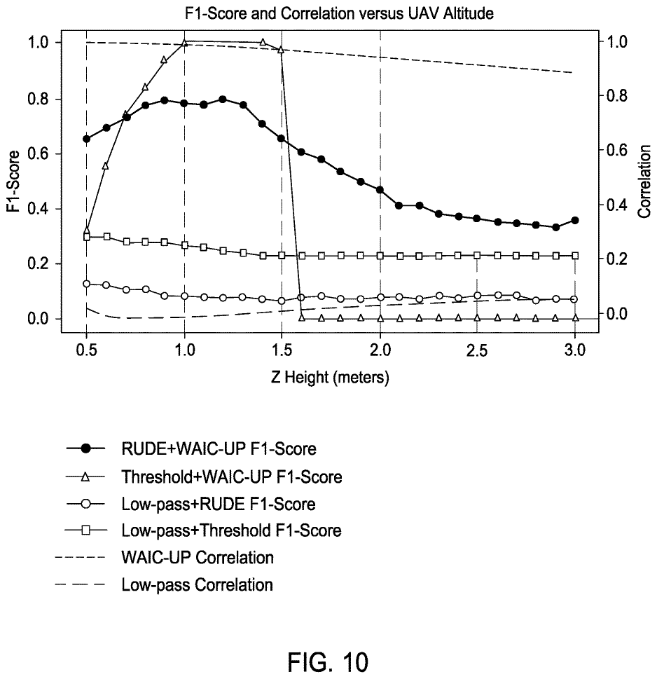

Four combinations of interference removal and detection methods were compared: WAIC-UP+RUDE, Iowpass filtering+RUDE, WAIC-UP+thresholding, and low-pass filtering+thresholding. The results, shown in FIG. 10, indicate that both WAIC-UP-based methods outperformed the low-pass filter across all altitudes in terms of F1-Score and correlation to the true landmine signals.

WAIC-UP combined with RUDE achieved its highest F1-Score, peaking at approximately 0.80 between 0.7 and 1.3 meters altitude. However, performance steadily declined at higher altitudes, indicating reduced sensitivity at greater distances from the landmines. WAIC-UP combined with thresholding performed exceedingly well between 1 and 1.5 meters, where the F1-Score remained high, but exhibited a sharp drop-off after 1.4 meters. This drop occurred because the strength of the landmine signal at greater UAV altitudes fell below the 25 nT threshold, effectively zeroing out the detection performance beyond that range. This demonstrates that while WAIC-UP with thresholding is effective at moderate altitudes, it is particularly sensitive to signal strength, making it vulnerable to altitude increases.

In contrast, the low-pass filter-based methods performed consistently poorly, with both combinations maintaining an F1-Score below 0.4 across all altitudes. The Pearson correlation coefficient results further confirmed the superior performance of WAIC-UP, achieving near-perfect correlation at lower altitudes, while low-pass filtering struggled to remove interference adequately, resulting in poor correlation with the true landmine signal.

By combining WAIC-UP and RUDE, a low-cost and computationally efficient solution that enhances the accuracy and reliability of object detection using UAV-mounted magnetometers results. This approach eliminates the need for bulky equipment and expert intervention, thereby reducing operational costs and complexities. Implementing this approach has the potential to significantly improve demining operations, facilitating the safe and rapid clearance of hazardous areas and contributing to the restoration of safe and productive lands in post-conflict regions.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for detecting metal objects using an unmanned aerial vehicle (UAV), the UAV configured with a pair of magnetometers, comprising:
receiving, by a computer processor, a magnetic signal from each magnetometer in the pair of magnetometers;
applying, by the computer processor, a wavelet transform to the two magnetic signals, thereby yielding a first wavelet signal and a second wavelet signal;
calculating, by the computer processor, a difference between the first wavelet signal and the second wavelet signal;
computing, by the computer processor, a gain factor for the pair of magnetometers based in part of the difference between the first wavelet signal and the second wavelet signal, where the gain factor represents a difference in distance between an interference source and each of the magnetometers in the pair of magnetometers;
reconstructing, by the computer processor, an ambient magnetic field signal in wavelet domain using the gain factor;
applying, by the computer processor, an inverse wavelet transform to the ambient magnetic field signal in the wavelet domain to yield an ambient magnetic field signal in time domain; and
detecting, by the computer processor, an object using the ambient magnetic field signal in the time domain.

2. The method of claim 1 wherein the gain factor is computed by defining a mathematical expression for each of the two magnetic signals, where the gain factor is a term in one of the mathematical expressions; rearranging the mathematical expressions to isolate the interference source; and determining the gain factor by defining a ratio between the mathematical expressions.

3. The method of claim 1 wherein the gain factor is computed according to
$$\frac{\sum D ( s ) W 2 ( s )}{\sum D ( s ) W 1 ( s )} ,$$
where D(s) the difference between the first wavelet signal and the second wavelet signal, W₁(s) is the first wavelet signal, and W₂(s) is the second wavelet signal.

4. The method of claim 1 wherein the ambient magnetic field signal in the wavelet domain is computed according to
$$\frac{\hat{K} ( s ) W 1 ( s ) - W 2 ( s )}{\hat{K} ( s ) - 1} ,$$
where \hat{K} (s) is the computed gain factor, W₁(s) is the first wavelet signal, and W₂(s) is the second wavelet signal.

5. The method of claim 1 wherein detecting an object using the ambient magnetic field signal in the time domain includes:
identifying anomalies in the ambient magnetic field signal in the time domain;
receiving position data for the UAV;
correlating the identified anomalies with the position data of the UAV; and
reporting occurrence of an object at the identified anomalies, along with position data of the UAV at the identified anomalies.

6. The method of claim 5 further comprises identifying anomalies in the ambient magnetic field signal in the time domain using a support vector machine.

7. The method of claim 6 wherein the support vector machine is further defined as a one-class support vector machine.

8. The method of claim 6 further comprises, prior to identifying anomalies in the ambient magnetic field signal, applying principal component analysis to the ambient magnetic field signal in the time domain.

9. A method for detecting metal objects using an unmanned aerial vehicle (UAV), the UAV configured with a pair of magnetometers, comprising:
receiving, by a computer processor, a magnetic signal from each magnetometer in the pair of magnetometers;
deriving, by the computer processor, an ambient magnetic field signal from the two magnetic signals using a Wavelet-Adaptive Interference Cancellation for Underdetermined Platforms method;
identifying, by the computer processor, anomalies in the ambient magnetic field signal;
receiving, by the computer processor, position data for the UAV;
correlating, by the computer processor, the identified anomalies with the position data of the UAV; and
reporting, by the computer processor, occurrence of an object at the identified anomalies, along with position data of the UAV at the identified anomalies.

10. The method of claim 9 wherein the step of deriving an ambient magnetic field signal includes
applying, by the computer processor, a wavelet transform to the two magnetic signals, thereby yielding a first wavelet signal and a second wavelet signal;
calculating, by the computer processor, a difference between the first wavelet signal and the second wavelet signal;
computing, by the computer processor, a gain factor for the pair of magnetometers based in part of the difference between the first wavelet signal and the second wavelet signal, where the gain factor represents a difference in distance between an interference source and each of the magnetometers in the pair of magnetometers;
reconstructing, by the computer processor, an ambient magnetic field signal in wavelet domain using the gain factor;
applying, by the computer processor, an inverse wavelet transform to the ambient magnetic field signal in the wavelet domain to yield an ambient magnetic field signal in time domain; and
detecting, by the computer processor, an object using the ambient magnetic field signal in the time domain.

11. The method of claim 9 wherein the anomalies in the ambient magnetic field signal are identified using a support vector machine.

12. A non-transitory computer-readable medium having computer-executable instructions that, upon execution of the instructions by a processor of a computer, cause the computer to:
receive a magnetic signal from each magnetometer in a pair of magnetometers, where the pair of magnetometers are equipped on an unmanned aerial vehicle (UAV);
apply a wavelet transform to the two magnetic signals, thereby yielding a first wavelet signal and a second wavelet signal;
calculate a difference between the first wavelet signal and the second wavelet signal;
compute a gain factor for the pair of magnetometers based in part of the difference between the first wavelet signal and the second wavelet signal, where the gain factor represents a difference in distance between an interference source and each of the magnetometers in the pair of magnetometers;
reconstruct an ambient magnetic field signal in wavelet domain using the gain factor;
apply an inverse wavelet transform to the ambient magnetic field signal in the wavelet domain to yield an ambient magnetic field signal in time domain; and
detect an object using the ambient magnetic field signal in the time domain.

13. The non-transitory computer-readable medium of claim 12 wherein the gain factor is computed by defining a mathematical expression for each of the two magnetic signals, where the gain factor is a term in one of the mathematical expressions; rearranging the mathematical expressions to isolate the interference source; and determining the gain factor by defining a ratio between the mathematical expressions.

14. The non-transitory computer-readable medium of claim 12 wherein the gain factor is computed according to
$$\frac{\sum D ( s ) W 2 ( s )}{\sum D ( s ) W 1 ( s )} ,$$
where D(s) the difference between the first wavelet signal and the second wavelet signal, W₁(s) is the first wavelet signal, and W₂(s) is the second wavelet signal.

15. The non-transitory computer-readable medium of claim 12 wherein the ambient magnetic field signal in the wavelet domain is computed according to
$$\frac{\hat{K} ( s ) W 1 ( s ) - W 2 ( s )}{\hat{K} ( s ) - 1} ,$$
where K (s) is the computed gain factor, W₁(s) is the first wavelet signal, and W₂(s) is the second wavelet signal.

16. The non-transitory computer-readable medium of claim 12 wherein detecting an object using the ambient magnetic field signal in the time domain includes:
identifying anomalies in the ambient magnetic field signal in the time domain;
receiving position data for the UAV;
correlating the identified anomalies with the position data of the UAV; and
reporting occurrence of an object at the identified anomalies, along with position data of the UAV at the identified anomalies.

17. The non-transitory computer-readable medium of claim 16 wherein the anomalies in the ambient magnetic field signal are identified using a support vector machine.

18. A method for detecting metal objects using an unmanned aerial vehicle (UAV), the UAV configured with two or more magnetometers, comprising:
receiving, by a computer processor, a magnetic signal from each magnetometer in the two or more magnetometers;
applying, by the computer processor, a wavelet transform to the magnetic signals from the two or more magnetometers, thereby yielding a set of wavelet signals;
calculating, by the computer processor, a difference between signals in the set of wavelet signals;
computing, by the computer processor, a gain factor for the two or more magnetometers based in part of the difference between the signals in the set of wavelet signals, where the gain factor represents a difference in distance between an interference source and each of the magnetometers in the two or more magnetometers;
reconstructing, by the computer processor, an ambient magnetic field signal in wavelet domain using the gain factor;
applying, by the computer processor, an inverse wavelet transform to the ambient magnetic field signal in the wavelet domain to yield an ambient magnetic field signal in time domain; and
detecting, by the computer processor, an object using the ambient magnetic field signal in the time domain.
